(19) United States
(12) Patent Application Publication
(10) Pub. No.: US 2010/0302235 A1
(43) Pub. Date: Dec. 2, 2010

(54) efficient composition of a stereoscopic image for a 3-D TV

(75) Inventors: Nir Darshan, Petach-Tiqua (IL); Ilan Dimnik, Rishon Le Zion (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/476,317

(22) Filed: Jun. 2, 2009

(51) Int. Cl. G06T 15/00; G09G 5/00

(52) U.S. Cl. 345/419; 345/630

(57) ABSTRACT

The present invention relates to a method for efficiently composing multiple images into one stereoscopic image comprising the steps of: (a) receiving a first image of said multiple images; (b) blending said first image with a mask, using a pixel base blender, for producing a first blended image; (c) receiving a second image of said multiple images; and (d) blending said second image with said first blended image, using a pixel base blender, for composing said stereoscopic image.

### FIELD OF THE INVENTION

The present invention relates to the field of stereoscopic imaging. More particularly, the invention relates to a method for efficiently composing multiple images into one stereoscopic image for 3-Dimensional TVs.

### BACKGROUND OF THE INVENTION

Utilizing the inherent speed advantages of the Digital Micro-mirror Device (DMD), DLP televisions can display the alternating left and right views in the required speed for stereoscopic 3-D imaging. When combined with shutter glasses, users can experience high definition 3-D viewing with DLP HDTVs. DLP 3-D HDTV technology generates alternating independent views for the left and right eyes. A synchronization signal is generated for each view and transmitted to the shutter glasses that are worn by the viewer. The shutter glasses process the signal and control the shutter for each eye, insuring display of the correct view for each eye.

The DLP 3-D HDTV technology supplies a 60 Hz frame rate signal to each eye (equivalent to 120 Hz). This high video frame rate reduces flicker which is typical of other frame sequential stereographic display systems. A DLP 3-D HDTV system with shutter glasses can offer good color fidelity and advanced picture depth.

In order to display a stereoscopic video, 3-D stereoscopic video content is sent to the DLP TV digitally, through an HDMI or DVI port. Left and right stereo images are independently filtered, then sampled in an offset grid pattern. The resulting views are then combined, and appear as a left and right, i.e. as black and white in a checkerboard pattern, in a conventional orthogonal sampled image. This format preserves the horizontal and vertical resolution of the left and right views providing the viewer with a high quality image within a set bandwidth.

DLP 3-D Technology uses subframes to generate independent views for the left and right eyes. A signal is generated for each subframe and transmitted to the shutter glasses that are worn by the viewer. The shutter glasses process the signal and control the shutter for each eye to ensure that the correct left and right views are displayed to the correct eye. One advantage in using this method for stereoscopic display is its cost effectiveness as other stereoscopic displays typically require two times the imaging bandwidth of the standard 2-D displays. For a 1080 p television set, this means that two 1080 p input streams are required. This method maintains both the vertical and the horizontal resolution, and produces a high quality and high resolution displays for stereoscopic viewing.

It is an object of the present invention to provide a method for efficiently composing two images into a stereoscope display.

It is another object of the present invention to provide a method for efficiently composing a 3-D image for a DPL TV.

It is still another object of the present invention to provide a method for efficiently displaying a 3-D video.

It is still another object of the present invention to provide a method for efficiently displaying a plurality of 3-D media contents.

Other objects and advantages of the invention will become apparent as the description proceeds.

### SUMMARY OF THE INVENTION

The present invention relates to a method for efficiently composing multiple images into one stereoscopic image comprising the steps of (a) receiving a first image of said multiple images; (b) blending said first image with a mask, using a pixel base blender, for producing a first blended image; (c) receiving a second image of said multiple images; and (d) blending said second image with said first blended image, using a pixel base blender, for composing said stereoscopic image.

In one embodiment, the mask is a checkerboard mask.

In another embodiment, the mask is a line interleaved mask.

In one embodiment, the blender, for blending the first image with a mask, performs the A atop B operation.

In another embodiment, the blender for blending the first image with a mask performs the A in B operation.

Preferably, the blender for blending the second image with the first blended image performs the A over B operation.

In one embodiment, the first and second images belong to the AVC standard.

In one embodiment, the mask is a predesigned mask stored in the system.

The present invention also relates to a method for efficiently composing multiple images into one stereoscopic image comprising the steps of: (a) receiving a first image of said multiple images; (b) receiving a second image of said multiple images; (c) blending said first image with second image, using a pixel base blender, for producing a first blended image; (d) blending said first blended image with a mask, using a pixel base blender, for producing a second blended image; (e) receiving a third image of said multiple images; (f) blending said third image with said second blended image, using a pixel base blender, for producing a third blended image; (g) receiving a fourth image of said multiple images; and (h) blending said fourth image with said third blended image, using a pixel base blender, for producing said stereoscopic image.

### BRIEF DESCRIPTION OF THE DRAWINGS

In the drawings:

FIG. 1 is a schematic diagram depicting a prior art method for combining two images into one checkerboard stereoscopic image.

FIG. 2 schematically illustrates the method of composing two images into one stereoscopic image according to an embodiment of the invention.

FIG. 3 is a visual example for depicting the method of the invention according to one embodiment.

FIG. 4 schematically illustrates the method of composing two pairs of images into one stereoscopic image according to an embodiment of the invention.

FIG. 5 schematically illustrates the method of composing two images into one stereoscopic image according to another embodiment of the invention.

### DETAILED DESCRIPTION OF PREFERRED EMBODIMENTS

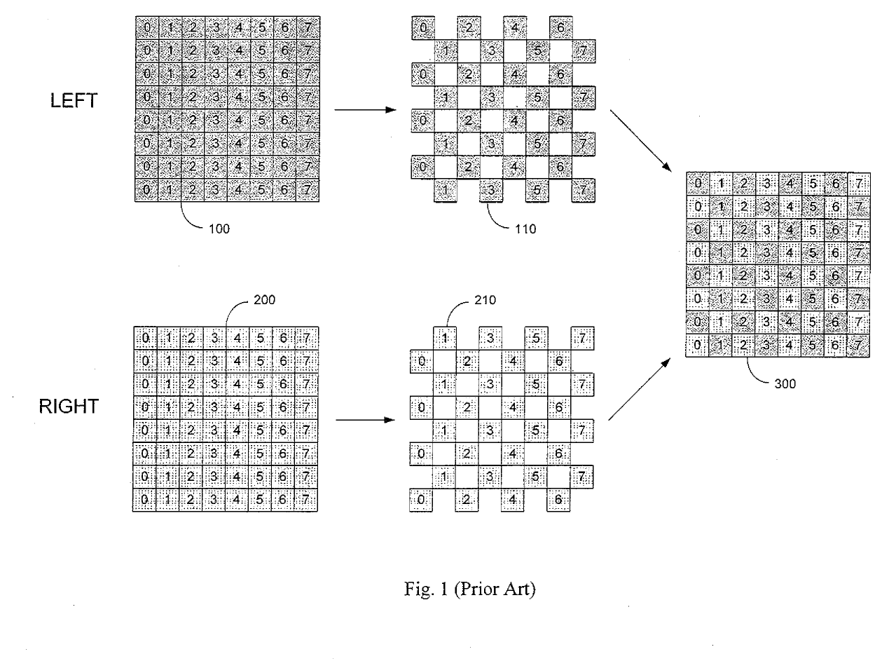

FIG. 1 is a schematic diagram depicting a prior art method for composing two images into one checkerboard stereoscopic image. In order to display a correct stereoscopic image, two images of two viewing angles are required, where the two viewing angles are the two angles viewed from the left eye and right eye. At first, two images, 100 and 200, are made which display the required view from two angles. Image 100 represents the view intended for the left eye and image 200 represents the view intended for the right eye. Each image is then filtered using one of the 2-D diagonal filters. For example if the left view 100 is filtered using one 2-D diagonal filter which resembles the black squares of a checkerboard, the right view 200 is filtered with the inversed 2-D diagonal filter which resembles the white squares of a checkerboard. Thus the filtered left view image 110 is in fact the complementary of the filtered right view image 210. For the sake of brevity the two filtered images 110 and 210 are illustrated in broad squares, however, in practice these images 110 and 210 are filtered using pixel fine diagonal filters, which are pixel based spatial altering black-white checkerboard form grid. Thus each square in images 110 and 210 resembles one pixel. Both images 110 and 210 are then combined into one stereoscopic view 300 which is sent to a DPL 2-D TV screen. The DPL TV then displays the received image in 2 parts, first one of the diagonal filtered image and then the second diagonal filtered image, where the display is synchronized with the shutter glasses of the viewer. Thus the viewer receives one image for the right eye and one image for the left eye. Although each received image is in fact only half an image, the eye, viewing the image, compensates for the darkened pixels of the checkerboard format and helps the viewer perceive the half image as a full image. Since the DLP TV screen may be set to a refresh rate of 120 p, which is twice the rate of a typical TV, the two images of left and right may be displayed in the same time it takes a typical TV to display a single image.

Another prior art method composes the two images of left and right into one stereoscopic image by selecting pixels in an alternating sequence between the left and right images and setting them in a stereoscopic image. In other words, the method requires copying pixels one by one from the two initial images in an alternating checkerboard form in order to produce a stereoscopic checkerboard image. For example, in this prior art method the upper left most pixel is copied from the left image and set for the upper left most pixel of the stereoscopic image, after which the upper second left pixel is copied from the right image and set for the upper second left pixel of the stereoscopic image, and so on.

In a paper, which is incorporated herein by reference, titled “Compositing Digital Images” by Thomas Porter and Tom Duff, Computer Graphics, Volume 18, Number 3, July 1984, a case is presented for processing the matte aspect of pixels in an image. The paper, referred to hereinafter as Porter-Duff, deals with the matte aspect of pixels that comprise 4 components: Red Green Blue and Alpha (RGBA). The paper introduces the equations for calculating the pixels of a new image produced from the blending of pixels of two initial images:

C₀=α_{A}F_{A}C_{A}+α_{A}F_{B}C_{B}

α₀=α_{A}F_{A}+α_{B}F_{B}

Where C₀ is the color component of the RGB color scheme of the new pixel derived from blending two corresponding pixels of two initial images, and the as is its Alpha component. C_{A} and C_{B} are the color components of the RGB color schemes of the corresponding pixels of the two initial images, and α_{A} and α_{B} are the Alpha components of the corresponding pixels of the two initial images. The paper also discusses the 12 distinct composing operations between two images where F_{A} and F_{B} are the different functions used for the different blending operations.

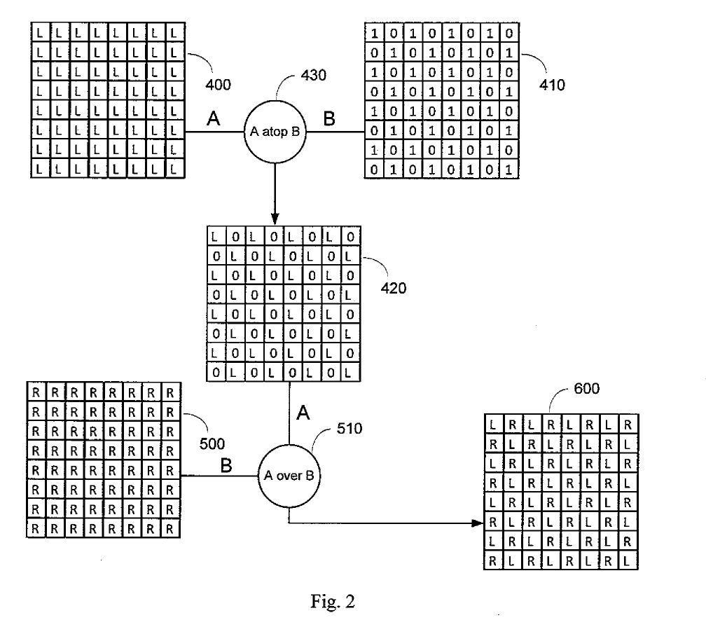

FIG. 2 schematically illustrates the method of composing two images into one stereoscopic image, using the Alpha blending methods described in Porter-Duff, according to an embodiment of the invention. For the sake of brevity the following description starts with the blending of the left image, although the terms “left” and “right” may be interchanged throughout the description according to the use and the implemented standard. All the pixels of both images 400 and 500 are assumed to have four components RGBA, where their Alpha component is set to 1, or a variation thereof, before composition. For the sake of brevity all the following images and masks are illustrated by set squares having a small number of tiles/squares resembling pixels, nevertheless, the invention may be practiced with images and masks having any set of any numbers of pixels. The checkerboard mask 410 is actually an image that all its pixels are set to black, i.e. RGB={0, 0, 0}, and its pixels' Alpha is set either to 1 or to 0 in a diagonal checkerboard format. The set numbers of the checkerboard mask image 410 schematically depict the alternating value of the pixels' Alpha which can be 0 or 1. Left image 400 is then blended with the checkerboard mask 410 in pixel base blender 430. The blending of left image 400 and checkerboard 410 can be done using the blending operation A atop B discussed in Porter-Duff mentioned above, where the left image 400 is the A atop checkerboard mask 410 which is B. As stated in Porter-Duff, in this case F_{A}=α_{B} and F_{B}=1−α_{A}. Therefore, when set in the equations above we receive the following:

C₀=α_{A}α_{B}C_{B}(1−α_{A})C_{B}

α₀=α_{A}α_{B}+α_{B}(1−α_{A})

However since α_{A} is equal to 1 for all the pixels, we receive the following:

C₀=α_{B}C_{A}

α₀=α_{B}

Thus the produced pixels of the blended image are in full correlation with the α_{B} component. For the blended pixels corresponding to the α_{B}=1 pixels of the checkerboard mask, C₀=C_{A}, meaning that these pixels have a color scheme of their corresponding pixels from the left image and an Alpha equal to 1. For the blended pixels corresponding to the α_{B}=0 pixels of the checkerboard mask, C₀=0, meaning that these pixels have a black RGB coloring and their Alphas are equal to 0. Image 420 schematically depicts the blending of left image 400 with the checkerboard mask of 410. At this stage, the blended image 420 is then blended, in pixel base blender 510, with the right image 500, which may be done using the blending operation A over B discussed in Porter-Duff, where the blended image 420 is the A over right view 500 which is B. As stated in Porter-Duff, in this case F_{A}=1 and F_{B}=1−α_{A}. Therefore, when set in the equations above we receive the following:

C₀=α_{A}C_{A}+α_{B}(1−α_{A})C_{B}

α₀=α_{A}+α_{B}(1−α_{A})

However since α_{B} is equal to 1 for all pixels, we receive the following:

C₀=α_{A}C_{A}+(1−α_{A})C_{B}

α₀=1

Since two cases are possible where α_{A} is either equal to 0 or equal to 1:

If α_{A}=1 then:

C₀=C_{A}

If α_{A}=0 then:

C₀=C_{B}

Therefore, for the blended pixels corresponding to the α_{A}=1 pixels of the blended image 420, C₀=C_{A}, meaning that these pixels have a color scheme of their corresponding pixels from the left image 400 and an Alpha equal to 1. For the blended pixels corresponding to the α_{A}=0 pixels of the blended image 420, C₀=C_{B}, meaning that these pixels have a color scheme of their corresponding pixels from the right image 500 and an Alpha equal to 1. Thus an image 600 is received which is a stereoscope checkerboard image of two images left and right.

In one of the embodiments, the checkerboard mask is designed once and stored in the system that is intended for performing the blending. In another embodiment a checkerboard mask is designed for a number of images, a video, or a number of videos. Thus there is no need to create a new checkerboard mask for each stereoscopic image.

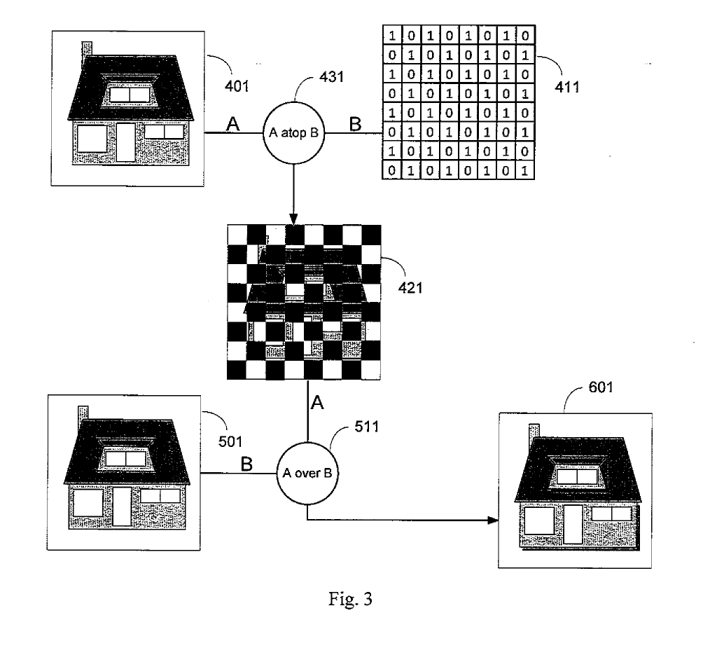

FIG. 3 is a visual example for depicting the method of the invention according to one embodiment. In this example both images 401 and 501 resemble two images with a slight deviation (the deviation is not depicted). For the sake of brevity the checkerboard mask is resembled by image 411, although in practice the checkerboard mask is a pixel fine diagonal filter fabricated for filtering pixels from their close pixel neighbors, thus each square in images 411 and 421 resembles one pixel. At first left image 401 is blended with the checkerboard mask 411 in pixel base blender 431. The blending of left image 401 and checkerboard 411 can be done using the blending operation A atop B discussed in Porter-Duff, where the left image 401 is the A atop checkerboard mask 411 which is B. Image 421 schematically depicts the blending of left image 401 with the checkerboard mask of 411. At this stage, the blended image 421 is blended, in pixel base blender 511, with the right image 501 using the blending operation A over B discussed in Porter-Duff, where the blended image 421 is the A over right view 501 which is B. Thus a stereoscope image is received which is resembled by image 601 (which does not illustrate a true stereoscope image).

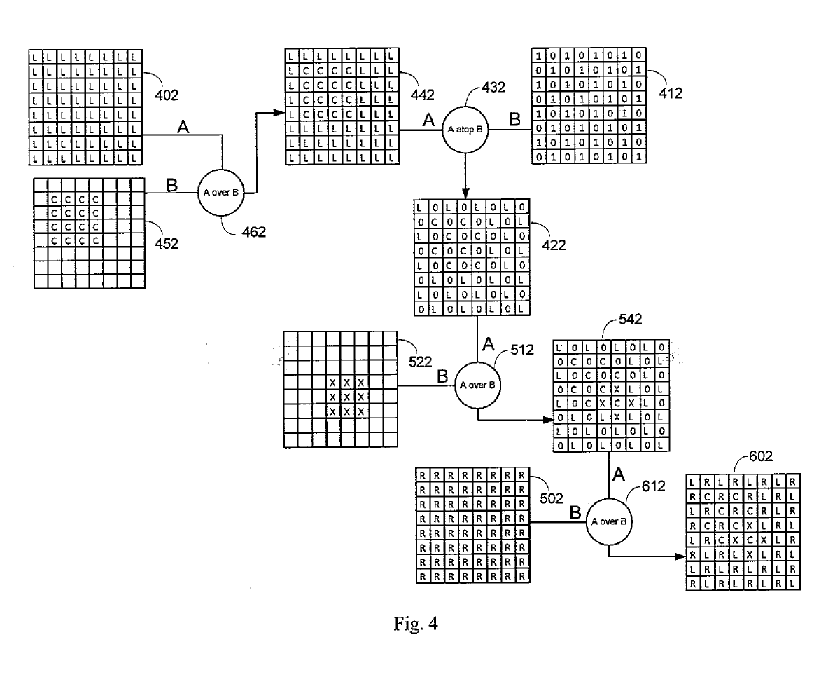

FIG. 4 schematically illustrates the method of composing four images into one stereoscopic image according to an embodiment of the invention. The images 402 and 502 resemble a left view image and a right view image respectively, similar to the described before. Image 452 resembles a graphic addition for the left view and image 522 resembles a graphic addition for the right view, whereas by graphic addition it is meant to include video, still image, or any multi media addition. All the pixels of the images 402 and 502 are assumed to have four components RGBA, where their Alpha component is set to 1, or a variation thereof, before composition. Images 452 and 522 may be the same size or smaller than images 402 and 502 and their pixels are assumed to have four components RGBA. For the sake of brevity all the following images and masks are illustrated by set squares having a small number of tiles resembling pixels, nevertheless, the invention may be practiced with images and masks having any set of any numbers of pixels. At first the left image 402 is blended with the graphics image 452 in pixel base blender 462. The blending of left image 402 and graphics image 452 can be done using the blending operation B over A discussed in Porter-Duff mentioned above, where the graphics image 452 is the B over left image 402 which is A. As stated in Porter-Duff, in this case F_{A}=1−α_{B} and F_{B}=1. Therefore, when set in the equations above we receive the following:

C₀=α_{A}(1−α_{B})C_{A}+α_{B}C_{B}

α₀=α_{A}(1−α_{B})+α_{B}

However since α_{A} is equal to 1 for all the pixels, we receive the following:

C₀=(1−α_{B})C_{A}+α_{B}C_{B}

α₀=1

Thus the produced pixels of the blended image 442 are a blend of the pixels of the initial images 402 and 452. The checkerboard mask 412 is actually an image that all its pixels are set to black, i.e. RGB={0, 0, 0}, and its pixels' Alpha is set either to 1 or to 0 in a diagonal checkerboard format. The set numbers of the checkerboard mask image 412 schematically depict the alternating value of the pixels' Alpha which can be 0 or 1. The blended image 442 is then blended with the checkerboard mask 412 in pixel base blender 432. The blending of blended image 442 and checkerboard 412 can be done using the blending operation A atop B discussed in Porter-Duff, where the blended image 442 is the A atop checkerboard mask 412 which is B. As stated in Porter-Duff, in this case F_{A}=α_{B} and F_{B}=1−α_{A}. Therefore, when set in the equations above we receive the following:

C₀=α_{A}α_{B}C_{A}+α_{B}(1−α_{A})C_{B}

α₀=α_{A}α_{B}+α_{B}(1−α_{A})

However since α_{A} is equal to 1 for all the pixels, we receive the following:

C₀=α_{B}C_{A}

α_{A}=α_{B}

Thus the produced pixels of the new blended image 422 are in full correlation with the α_{B} component. For the blended pixels corresponding to the α_{B}=1 of the checkerboard mask, C₀=C_{A}, meaning that these pixels have a color scheme of their corresponding pixels from the blended image 442 and an Alpha equals to 1. For the blended pixels corresponding to the α_{B}=0 pixels of the checkerboard mask, C₀=0, meaning that these pixels have a black RGB coloring and their Alphas are equal to 0. Image 422 schematically depicts the blending of the blended image 442 with the checkerboard mask of 412. At this stage, the blended image 422 is blended; in pixel base blender 512, with the right graphics image 522, which may be done using the blending operation A over B discussed in Porter-Duff, where the blended image 422 is the A over right graphics image 522 which is B. As stated in Porter-Duff, in this case F_{A}=1 and F_{B}=1−α_{A}. Therefore, when set in the equations above we receive the following:

C₀=α_{A}C_{A}+α_{B}(1−α_{A})C_{B}

α₀=α_{A}+α_{B}(1−α_{A})

Since two cases are possible where α_{A} is either equal to 0 or equal to 1:

If αA=1 then:

C₀=C_{A}

α₀=α_{A}=1

If α_{A}=0 then:

C₀=α_{B}C_{B}

α₀=α_{B}

Therefore, for the blended pixels corresponding to the α_{A}=1 pixels of the blended image 422, C₀=C_{A}, meaning that these pixels have a color scheme of their corresponding pixels from the blended image 422 and an Alpha equal to 1. For the blended pixels corresponding to the α_{A}=0 pixels of the blended image 422, C₀=α_{B}C_{B}, meaning that these pixels have an Alpha and color scheme of their corresponding pixels from the right graphics image 522. At this stage, the blended image 542 is then blended, in pixel base blender 612, with the right image 502, which may be done using the blending operation A over B discussed in Porter-Duff, where the blended image 542 is the A over right image 502 which is B. As stated in Porter-Duff, in this case F_{A}=1 and F_{B}=1−α_{A}. Therefore, when set in the equations above we receive the following:

C₀=α_{A}C_{A}+α_{B}(1−α_{A})C_{B}

α₀=α_{A}+α_{B}(1−α_{A})

However since α_{B} is equal to 1 for all the pixels, we receive the following:

C₀=α_{A}C_{A}+(1−α_{A})C_{B}

α₀=1

If α_{A}=1 then:

C₀=C_{A}

If α_{A}=0 then:

C₀=C_{B}

If 0<α_{A}<1 then:

C₀=α_{A}C_{A}+(1−α_{A})C_{B}

Therefore, for the blended pixels corresponding to the α_{A}=1 pixels of the blended image 542, C₀=C_{A}, meaning that these pixels have a color scheme of their corresponding pixels from the blended image 542 and an Alpha equal to 1. For the blended pixels corresponding to the α_{A}=0 of the blended image 542, C₀=C_{B}, meaning that these pixels have a color scheme of their corresponding pixels from the right image 502 and their Alphas are equal to 1. For the blended pixels corresponding to the 0<α_{A}<1 of the blended image 542, the pixels will have a color blend based on the α_{A}. Thus an image 602 is received which is a stereoscope image blend of the four initial images.

In one of the embodiments of the invention the method described in relation to FIG. 4 is used for blending more than 4 images. In this embodiment the left graphic images are blended over the left image, and the right graphic images are blended over the right image as described.

Some of the 3-D TVs use the line interleaved method for displaying a 3-D image such as the GD-463D10 which adopts the Xpol polarizing filter method. The Xpol method allocates images for the right and left eye to the odd and even-numbered horizontal lines of the screen. When viewed through a pair of dedicated circular polarization glasses, the image displayed on the odd numbered lines is visible to the right eye, but invisible to the left and vice versa for the even numbered lines.

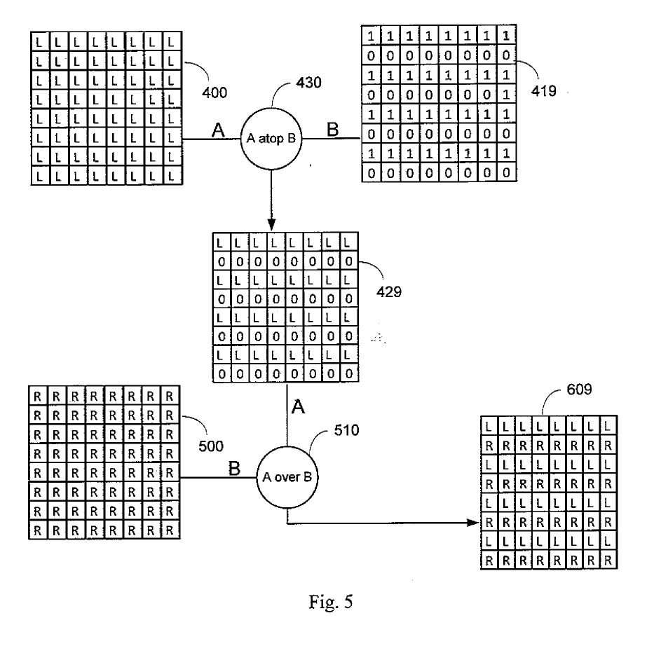

FIG. 5 schematically illustrates the method of composing two images into one stereoscopic image according to another embodiment of the invention. In this embodiment, the method of the invention may be used for TVs which display line interleaved stereoscope. The method of the invention may be used as described in relations to FIG. 2 where the images 400 and 500 are as described. Albeit, the checkerboard mask 410 is replaced with a line mask 419, which produces a line blended image 429. Thus when line blended image 429 is blended with the right image 500, the result is a line interleaved stereoscopic image 609. The method of the invention according to another embodiment may be used as described in relations to FIG. 4, where the checkerboard mask 412 is switched with the line mask 419, for TVs which display line interleaved stereoscope. Thus the method may be used for blending more than 4 images.

In some of the embodiments the pixel base blenders, described in FIG. 2-5, performing the blending function of A atop B may be switched to perform the blending function of A in B.

In one of the embodiments, the method of the invention is used for displaying a video where a number of images are blended into stereoscopic images one after another effectively composing a stereoscope movie.

In one of the embodiments the initial images belong to the Multiview Video Coding (MVC) standard. The MVC is an amendment to H.264/MPEG-4 AVC video compression standard developed with joint efforts by MPEG/VCEG that enables efficient encoding of sequences captured simultaneously from multiple cameras using a single video stream. The MVC may be used for encoding stereoscopic video, as well as free viewpoint television and multi-view 3D television.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for efficiently composing multiple images into one stereoscopic image comprising the steps of:
a. receiving a first image of said multiple images;
b, blending said first image with a mask, using a pixel base blender, for producing a first blended image;
c. receiving a second image of said multiple images; and
d. blending said second image with said first blended image, using a pixel base blender, for composing said stereoscopic image.

2. A method according to claim 1, where the mask is a checkerboard mask.

3. A method according to claim 1, where the mask is a line interleaved mask.

4. A method according to claim 1, where the blender, for blending the first image with a mask, performs the A atop B operation.

5. A method according to claim 1, where the blender for blending the first image with a mask performs the A in B operation.

6. A method according to claim 1, where the blender for blending the second image with the first blended image performs the A over B operation.

7. A method according to claim 1, where the first and second images belong to the AVC standard.

8. A method according to claim 1, where the mask is a predesigned mask stored in the system.

9. A method for efficiently composing multiple images into one stereoscopic image comprising the steps of
a. receiving a first image of said multiple images;
b. receiving a second image of said multiple images;
c. blending said first image with second image, using a pixel base blender, for producing a first blended image;
d. blending said first blended image with a mask, using a pixel base blender, for producing a second blended image;
e. receiving a third image of said multiple images;
f. blending said third image with said second blended image, using a pixel base blender, for producing a third blended image;
g. receiving a fourth image of said multiple images; and
h. blending said fourth image with said third blended image, using a pixel base blender, for producing said stereoscopic image.

10. A method according to claim 9, where the mask is a checkerboard mask.

11. A method according to claim 9, where the mask is a line interleaved mask.
